(19) United States
(12) Patent Application Publication
(10) Pub. No.: US 2015/0298594 A1
(43) Pub. Date: Oct. 22, 2015

(54) Collapsible All-Terrain Vehicle Cart

(71) Applicant: David Wayne Fisk, Alabaster, AL (US)

(72) Inventor: David Wayne Fisk, Alabaster, AL (US)

(21) Appl. No.: 14/657,367

(22) Filed: Mar. 13, 2015

Related U.S. Application Data
(60) Provisional application No. 61/980,908, filed on Apr. 17, 2014.

(51) Int. Cl. B60P 3/04; B62D 63/06

(52) U.S. Cl. CPC B60P 3/04; B62D 63/061

(57) ABSTRACT

The present disclosure provides a collapsible all-terrain vehicle cart comprising primary members, each positioned parallel to one another and having a hinge at one end of its length and a handle at the opposite end; secondary members, each positioned parallel to one another, wherein one end of each of the secondary members is connected to the hinge end of a primary member and is able to rotate about a hinge relative to the primary member to which it is connected; cross members connecting the parallel primary and secondary members; hook plates connected to a cross member connecting the secondary members; hooks connected to the hook plates; wheels and wheel connectors; a coupler attachment; a trailer tongue connected to the coupler attachment, wherein the coupler attachment is able to rotate about a hinge relative to the trailer tongue; and at least one securing hook.

### CROSS-REFERENCE TO RELATED APPLICATIONS

This application claims the benefit of, and priority to, pending U.S. Provisional Application No. 61/980,908 filed Apr. 17, 2014 titled “Collapsible ATV Cart for Transporting Wild Game.”

### FIELD OF THE INVENTION

The invention relates generally to a device useful while hunting and more specifically relates to a device particularly useful while transporting wild game.

### BACKGROUND ART

Hunters often travel to their hunting sites on all-terrain vehicles (“ATVs”), rather than in a larger vehicle, such as a truck or sport utility vehicle. In the event the hunter is targeting large prey, a successful hunt can sometimes result in very bulky cargo for purposes of returning home. Therefore, hunters of wild game who are not in larger vehicles frequently need a method of transporting their prey home.

To accomplish this, some hunters currently use ATV trailers that are akin to larger vehicle trailers, which are structurally rigid. However, the trailer must always be pulled behind the ATV, even when empty, so that the performance of the ATV is hampered. Alternatively, the current carts must be loaded onto the ATV or towed separately in order to be useful when needed. A hunter does not know whether he will be successful, and if not, he has unnecessarily pulled an empty trailer to the hunting site and back. Finally, ATV operators other than hunters may find themselves in situations where they need a trailer for various items, but did not have prior notice in order to pull one.

The present invention provides a collapsible cart for pulling behind an ATV that is still sturdy enough to transport large game. The collapsible ATV cart can be folded up so that it rests on the rack which is located at the rear of the ATV, allowing it to be permanently attached to the ATV and only unfolded when needed. This keeps the cart off the ground, permitting the ATV to function at its normal capacity with no trailer to hinder performance. In addition, the collapsible ATV cart allows a hunter who may be alone to transport his game without the assistance of others. The present invention also includes features such as securing hooks and handles, so that game can be secured with straps or cords, and may be pulled by a person rather than an ATV.

### SUMMARY OF THE INVENTION

In view of the foregoing shortcomings inherent in the conventional type of methods and systems now present in the prior art, the present invention provides a cart for all-terrain vehicles that can be removable or permanently attached to the vehicle, used for transporting wild game (or other objects), and has the capability to be folded into sections.

In one embodiment, the collapsible all-terrain vehicle cart comprises a plurality of primary members, each positioned parallel to one another and further comprising a hinge at one end of its length; at least two cross members connecting the parallel primary members; a plurality of secondary members, each positioned parallel to one another, wherein one end of each of the secondary members is connected to the hinge end of a primary member, and wherein each of the secondary members is able to rotate about a hinge, relative to the primary member to which it is connected; at least two cross members connecting the parallel secondary members; at least two wheels; and a coupler attachment, further comprising a hinge at one end of its length.

In another embodiment, the collapsible all-terrain vehicle cart comprises a plurality of primary members, each positioned parallel to one another and further comprising a hinge at one end of its length and a handle at the end of its length opposite to the hinge end; at least two cross members connecting the parallel primary members; a plurality of secondary members, each positioned parallel to one another, wherein one end of each of the secondary members is connected to the hinge end of a primary member, and wherein each of the secondary members is able to rotate about a hinge, relative to the primary member to which it is connected; at least two cross members connecting the parallel secondary members; at least one hook plate connected to at least one cross member connecting the secondary members; at least one hook connected to a hook plate; at least two wheels; at least one wheel connector attached to at least one primary member and at least one wheel; a coupler attachment, further comprising a hinge at one end of its length; a trailer tongue connected to the coupler attachment at its hinge end, wherein the coupler attachment is able to rotate about a hinge relative to the trailer tongue to which it is connected; and at least one securing hook.

Other objects and advantages of the present invention will become obvious to the reader and it is intended that these objects and advantages are within the scope of the present invention.

To the accomplishment of the above and related objects, this invention may be embodied in the form illustrated in the accompanying drawings/pictures, recognizing however, that the drawings are illustrative only, and that changes may be made in the specific construction illustrated and described within the scope of the appended claims.

### BRIEF DESCRIPTION OF DRAWINGS

It should be noted that identical features in different drawings are shown with the same reference numeral. Various other objects, features and attendant advantages of the present invention will become fully appreciated as the same becomes better understood when considered in conjunction with the accompanying drawings.

FIG. 1 is a side perspective view of one embodiment of the collapsible ATV cart.

FIG. 2 is an alternate side perspective view of one embodiment of the collapsible ATV cart with the handles extended and the secondary portion unfolded.

FIG. 3 is an alternate side perspective view of one embodiment of the collapsible ATV cart with the handles contracted and the secondary portion unfolded.

FIG. 4 is a side view of one embodiment of the collapsible ATV cart attached to an ATV.

FIG. 5 is a side view of one embodiment of the collapsible ATV cart attached to an ATV in an alternate position.

### DETAILED DESCRIPTION

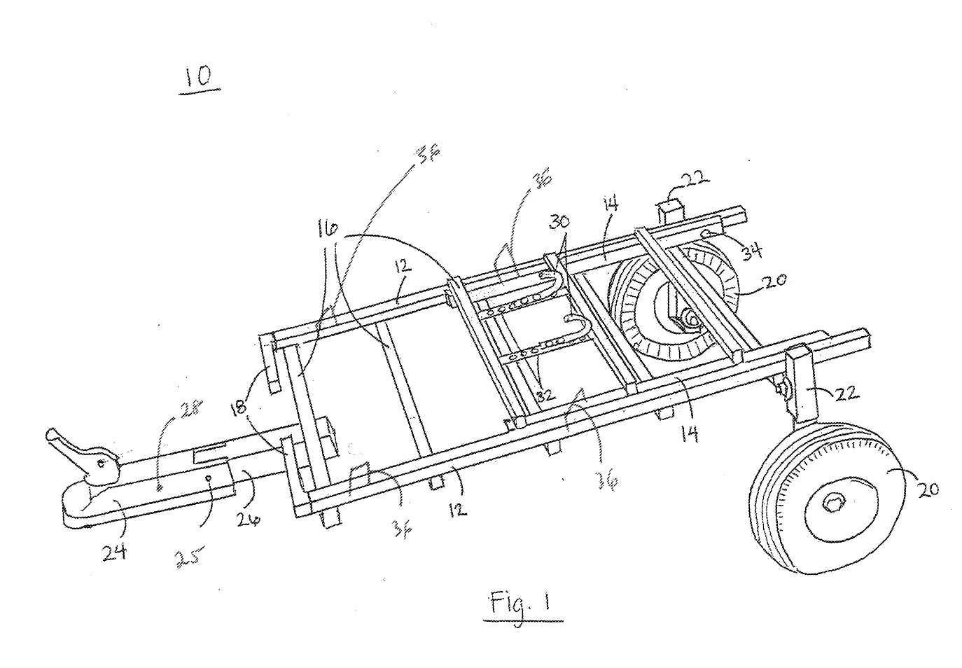

FIGS. 1 through 5 illustrate various views and embodiments of the present invention. In one embodiment, shown in FIGS. 1-5, the cart 10 comprises two primary members 12 in parallel and two secondary members 14 in parallel, each made of square tubing. Alternatively, the cart 10 may comprise three (3) or more primary members in parallel, or three (3) or more secondary members in parallel. The primary members 12 and secondary members 14 are shown as square tubing, but other shapes and materials are contemplated by the present invention. The primary members 12 can be of various lengths but are preferably between 24 and 48 inches in length or more preferably between 34 and 36 inches in length. The secondary members 14 can be of various lengths but are preferably between 18 and 36 inches in length or more preferably between 18 and 22 inches in length. Additionally, the primary members 12 and secondary members 14 can be of varying width, but are preferably between 1 and 2 inches in width.

As shown in the embodiment shown in FIGS. 1-5, the primary members 12 are secured to one another in parallel fashion by cross members 16. The cross members 16 connecting the primary members 12 can be of various lengths but are preferably between 18 and 36 inches in length or more preferably between 18 and 22 inches in length. The cross members 16 connecting the secondary members 12 can be of various lengths but are preferably between 12 and 24 inches in length or more preferably between 16 and 18 inches in length. FIG. 1 shows five (5) cross members 16 connecting the primary members 12, but the present invention contemplates two (2) or more cross members 16. Similarly, FIG. 1 shows three (3) cross members 16 connecting the secondary members 14, but more or less cross members 14 are contemplated by the present invention.

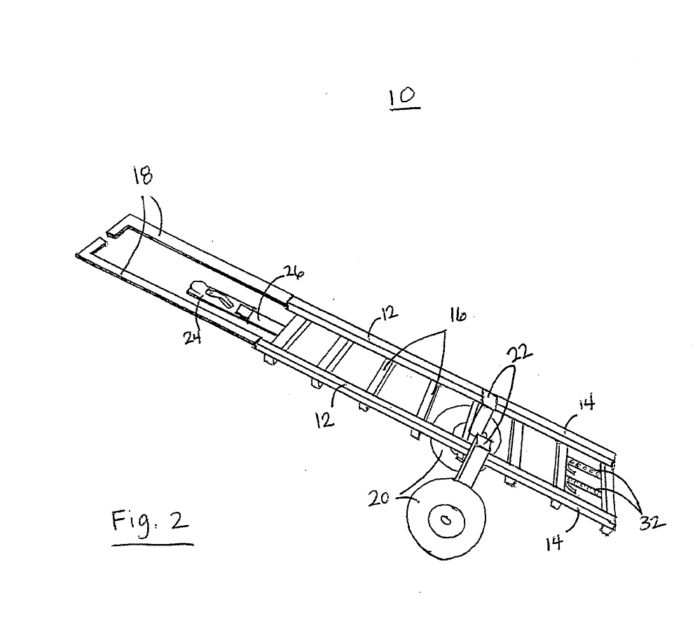

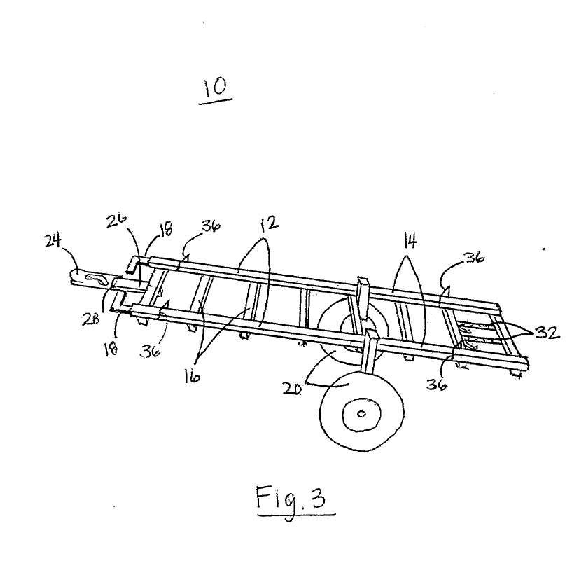

FIG. 1 shows handles 18 at one end of the primary members 12. In one embodiment, the handles 18 may be movable as further discussed below and shown in FIGS. 2 and 3.

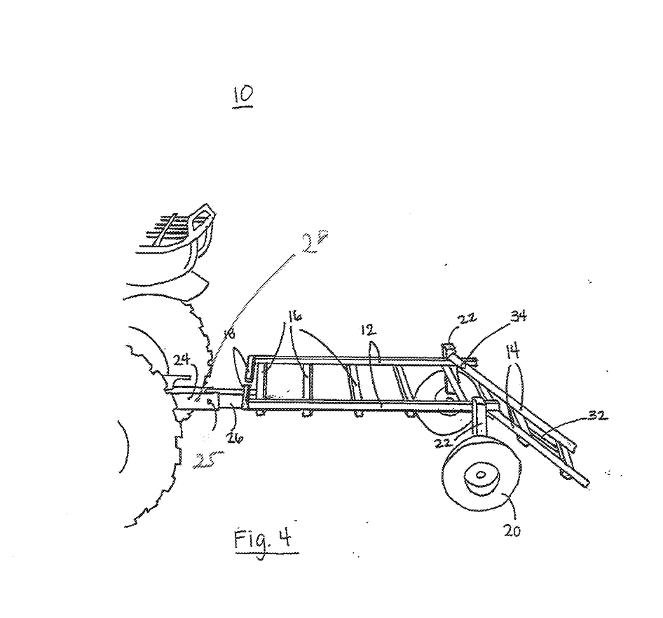

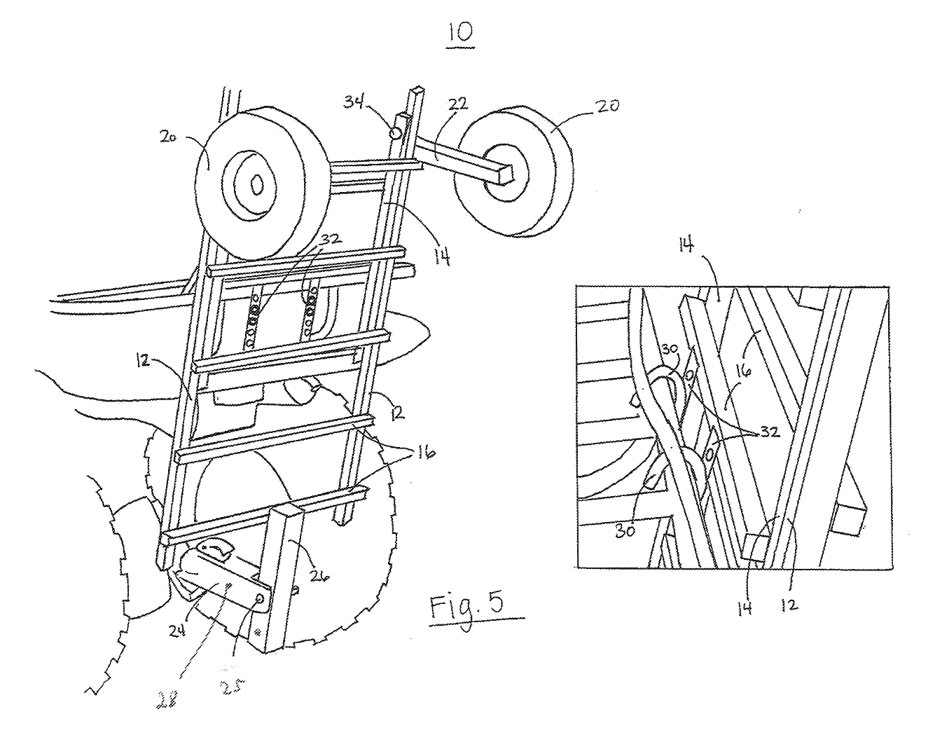

Additionally, as shown in the embodiment shown in FIGS. 1-5, the cart 10 may include a coupler attachment 26 positioned toward the front end of the primary members 12 and fixed to the first cross member 16. The coupler attachment 26 may be connected to a trailer tongue 24 by a nut and bolt 25 and may swivel (as described herein) via a trailer hinge pin 28, which is removable. The removable trailer hinge pin 28 allows the cart 10 to be rotated in relation to the trailer tongue 24, so that the cart 10 may be stored in an upright position while still attached to the trailer ball of an ATV. Accordingly, as shown in FIGS. 4-5, in one embodiment the cart 10 is rotatable about the hinge pin's 28 position from a first position to a second position. Although FIGS. 1-5 show the coupler attachment 26 connected to the trailer tongue 24 by way of a nut and bolt 25, other methods of connection may be used, such as a fixed hinge mechanism without a removable pin.

One embodiment of the present invention, as shown in FIGS. 1-5, shows the secondary members 14 connected to the primary members 12 by removable base hinge pins 34. These base hinge pins 34 are inserted into the back end (that is, the end opposite the handles 18 and coupler attachment 26) of the primary members 12, so that that base portion including the secondary members 14 may be rotated in relation to the base portion including the primary members 12, as further described below and shown in FIGS. 2 and 3. Although a base hinge pin 34 is shown in the present embodiment, other methods of connecting the two base portions may be used, such as fixed hinges or other methods allowing movement of the primary members 12 and secondary members 14 in relation to one another.

Because the cart 10 is intended to be pulled behind an ATV in a trailer-like fashion, FIG. 1 shows one embodiment of the present invention including wheels 20 attached to wheel connectors 22 which are in turn attached to the primary members 12. The wheel connectors 22 in this embodiment are shown as square tubing, but other materials or shapes are contemplated. Any type of method for connecting wheels to an ATV, trailer, vehicle, or cart may be used. Alternatively, the cart 10 may omit the use of connectors, and instead have the wheels 20 directly attached to any portion of the cart 10.

Finally, FIG. 1 shows the use of hook plates 32 and hooks 30 for securing to the all-terrain vehicle when not in use. In this embodiment, the hook plates 32 have pre-drilled holes and are fixed to the two cross members 16 at the farthest location from the trailer tongue 24. Hooks 30 are attached to the hook plates 32 by the use of hardware through the pre-drilled holes. When the cart 10 is in its folded position, and is rotated to a 90-degree, upright position as discussed above, the hooks 30 are positioned such that they can be used to secure the cart 10 to the ATV. In one embodiment, the hooks 30 are adapted and/or configured to engage a storage rack located on the rear of an ATV. Alternative configurations for the hook plates 32 can be used, such as the pre-drilling of one, long hole or slit. Using this method, hooks 30 that are attached via hardware could have the hardware loosened, and the hooks 30 could be slid up or down the length of the hook plates 32 before tightening hardware when the desired position is reached. The ability to move the location of the hooks 30 accommodates varying heights of the racks which are commonly on the rear portion of ATVs. As a result, when the cart 10 is in its folded, upright position, it rests both on the trailer hinge pin 28 which is attached to the trailer tongue 24, and the hooks 30 which are clasped to the ATV rack.

FIG. 2 illustrates one embodiment of the present invention, and shows the cart 10 in its unfolded position. Here, the base portion comprising the secondary members 14 has been rotated 180 degrees from its position as shown in FIG. 1, and is flat as compared to the base portion comprising the primary members 12. With the use of the base hinge pins 34, this can be accomplished by the removal of the base hinge pins 34, the rotation of the secondary members 14, and the re-insertion of the base hinge pins 34 to lock in place. Again, other means for attaching and rotating the two base halves may be used. This position elongates the cart 10 and provides the ability to transport a larger object or animal.

In addition, FIG. 2 shows handles 18 in an extended position. In this embodiment, handles 18 are comprised of square tubing that is smaller than the square tubing which makes up the primary members 12. The handles 18 can then be slid inside the hollow tubing of the primary members 12. Handles 18 can be extended, allowing a person to stand in front of the cart 10, hold the handles 18 behind him or her, and walk forward in order to transport an object or animal without the use of an all-terrain vehicle. The present invention contemplates that the handles 18 can be slid inside the primary members 12 for storage, and can be fastened with any number of connection methods. In addition, though square tubing is shown in this embodiment, other materials and shapes may be utilized. The handles 18, when extended from the primary members 12 allow a hunter to manually pull the cart 10 into or out of locations that are not accessible on the ATV.

FIG. 3 illustrates an alternative configuration of one embodiment of the present invention. The handles 18 are shown in a stored or contracted position, having been slid inside the primary members 12. The base portion comprising the secondary members 14 is shown in a flat, unfolded position, having been rotated 180 degrees from the position shown in FIG. 1. This position allows wild game or other objects to be transported behind an ATV when the trailer tongue 24 is attached to an ATV trailer ball.

Also illustrated in FIG. 3 are optional securing hooks 36, any number of which may be used. The securing hooks 36 may be attached to the primary members 12, secondary members 14, or cross members 16. These securing hooks 36 provide the ability to secure a load with straps, ropes, or elastic cords prior to transport. Though squared hooks are shown, any number of hooks, loops, or fasteners may be utilized as a method for anchoring or securing a load. In addition, the cart 10 may have holes in the primary members 12, secondary members 14, or cross members 16 in place of the securing hooks 36, allowing straps, ropes, or elastic cords to be directly hooked into the cart 10 for anchoring.

While the invention has been discussed as being useful to hunters for the transport of wild game, it should be recognized that the cart 10 can be used for a multitude of users other than hunters, such non-limiting examples include campers to transport camping equipment to a site, farmers to haul livestock feed, or recreational ATV operators to carry any number of items.

What is claimed is:

1. A collapsible all-terrain vehicle cart comprising:
a. a plurality of primary members, each positioned parallel to one another and further comprising:
i. a hinge at one end of its length;
b. at least two cross members connecting the parallel primary members;
c. a plurality of secondary members, each positioned parallel to one another,
wherein one end of each of the secondary members is connected to the hinge end of a primary member; and
wherein each of the secondary members is able to rotate about a hinge, relative to the primary member to which it is connected;
d. at least two cross members connecting the parallel secondary members;
e. at least two wheels; and
f. a coupler attachment, further comprising:
a hinge at one end of its length.

2. The collapsible all-terrain vehicle cart of claim 1 wherein each of the primary members further comprises a handle at the end opposite to its hinge end.

3. The collapsible all-terrain vehicle cart of claim 2 wherein each of the handles is permanently fixed to the primary member to which it is connected.

4. The collapsible all-terrain vehicle cart of claim 2 wherein each of the handles is a bar which is slidably inserted into the end of the primary member to which it is connected.

5. The collapsible all-terrain vehicle cart of claim 1 further comprising at least one hook plate which is connected to at least one cross member connecting the secondary members.

6. The collapsible all-terrain vehicle cart of claim 5 further comprising at least one hook connected to a hook plate.

7. The collapsible all-terrain vehicle cart of claim 5 wherein each of the hook plates further comprises at least one hole.

8. The collapsible all-terrain vehicle cart of claim 7 further comprising at least one hook connected to a hook plate.

9. The collapsible all-terrain vehicle cart of claim 1 further comprising a trailer tongue which is connected to the coupler attachment at its hinge end.

10. The collapsible all-terrain vehicle cart of claim 9 wherein the coupler attachment is able to rotate about a hinge relative to the trailer tongue to which it is connected.

11. The collapsible all-terrain vehicle cart of claim 1 further comprising at least one wheel connector, wherein the wheel connector is attached to at least one primary member and at least one wheel.

12. The collapsible all-terrain vehicle cart of claim 1 further comprising at least one securing hook.

13. A collapsible all-terrain vehicle cart, comprising:
a. a plurality of primary members, each positioned parallel to one another and further comprising:
i. a hinge at one end of its length; and
ii. a handle at the end of its length opposite to the hinge end;
b. at least two cross members connecting the parallel primary members;
c. a plurality of secondary members, each positioned parallel to one another,
wherein one end of each of the secondary members is connected to the hinge end of a primary member; and
wherein each of the secondary members is able to rotate about a hinge, relative to the primary member to which it is connected;
d. at least two cross members connecting the parallel secondary members;
e. at least one hook plate connected to at least one cross member connecting the secondary members;
f. at least one hook connected to a hook plate;
g. at least two wheels;
h. at least one wheel connector attached to at least one primary member and at least one wheel;
i. a coupler attachment, further comprising:
a hinge at one end of its length;
j. a trailer tongue connected to the coupler attachment at its hinge end;
wherein the coupler attachment is able to rotate about a hinge relative to the trailer tongue to which it is connected; and
k. at least one securing hook.

14. A collapsible all-terrain vehicle cart comprising:
a. a plurality of primary members, each positioned parallel to one another and further comprising a hinge at one end of their length;
b. at least two cross members connecting the parallel primary members;
c. a plurality of secondary members, each positioned parallel to one another, wherein one end of each of the secondary members is connected to the hinge end of a primary member; and wherein each of the secondary members is able to rotate about a hinge, relative to the primary member to which it is connected;
d. at least two cross members connecting the parallel secondary members;
e. at least two wheels; and
f. a coupler attachment, further comprising a coupler hinge at one end of its length, wherein the cart is rotatable from a first position to a second position about the coupler hinge such that in a first position the at least two wheels are in contact with the ground and in the second position the at least two wheels are not in contact with the ground.

15. The collapsible all-terrain vehicle cart of claim 14 wherein each of the primary members further comprises a handle at the end opposite to its hinge end.

16. The collapsible all-terrain vehicle cart of claim 15 wherein each of the handles is a bar which is slidably inserted into the end of the primary member to which it is connected.

17. The collapsible all-terrain vehicle cart of claim 16 further comprising at least one hook plate which is connected to at least one cross member connecting the secondary members.

18. The collapsible all-terrain vehicle cart of claim 17 further comprising at least one hook connected to a hook plate.
